(19) United States
(12) Patent Application Publication
(10) Pub. No.: US 2010/0228776 A1
(43) Pub. Date: Sep. 9, 2010

(54) SYSTEM, MECHANISMS, METHODS AND SERVICES FOR THE CREATION, INTERACTION AND CONSUMPTION OF SEARCHABLE, CONTEXT RELEVANT, MULTIMEDIA COLLAGES COMPOSITED FROM HETEROGENEOUS SOURCES

(76) Inventors: Ramaswamy N. Melkote, Mountain View, CA (US); Ramin Vatanparast, Redwood City, CA (US)

Correspondence Address: Ramaswamy N. Melkote, 245 Houghton Street, Mountain View, CA, 94041, US

(21) Appl. No.: 12/714,444

(22) Filed: Feb. 27, 2010

Related U.S. Application Data
(60) Provisional application No. 61/209,457, filed on Mar. 9, 2009.

(51) Int. Cl. G06F 3/048; G06F 17/30; G06F 17/00

(52) U.S. Cl. 707/770; 715/201; 715/760; 707/E17.014; 707/E17.032

(57) ABSTRACT

The current invention provides an enhanced user experience for consumers by minimizing the number of click-throughs, and optimizing time spent by providing customizable, interactive visual multimedia collages of information created from several sources of information in scrollable snapshots. Moreoyer, the same experience is made available for the users on-the-go on their mobile device where they can access the same collages and interact with them in a manner meaningful to the modalities provided on the mobile device, such as phone calls, text messaging, and Wireless Application Protocol (WAP) browser viewing. On the desktop Internet, interested consumers will be referred from the image collage result sets to content provider or retailers' web sites. Each image has all the information: the advertisement from the seller, customer review, product rating, and seller rating composited together. In one embodiment, the consumer can click on any of the regions of the collage (e.g. customer surveys) to click through to the WAP site or Internet site housing the information. In other embodiments, the consumer can just browse the information, consummate a buy transaction on-line: get it shipped or pick it up himself, place a bid for a used product, and/or call a number for more information. Through the system's analytics engine, the invention provides to the retailers competitive location-based information, consumer behavior data for advertising, and location based product demand. The consumer can save any of the interactive images and forward to others. For enterprises, retailers, and individuals interested in selling new/used products, they can create advertisements for their products using the Internet web based information collage authoring tool.

### PRIORITY CLAIM/CROSS REFERENCE TO RELATED APPLICATION

This application is related to and claims the priority and benefit from U.S. Provisional Patent application Ser. No. 61/209,457 filed Mar. 9, 2009, which is hereby incorporated by reference.

### FIELD OF THE INVENTION

Embodiments of the present invention relate generally to Internet and mobile visual search, technology and, more particularly, relate to methods, system and approach for desktop Internet and mobile users to access relevant product/service/content information in the form of multimedia collages composited from heterogeneous sources.

Multimedia collages are presentations for simultaneously visualizing content from a large number of multimedia sources, including but not limited to web content, video, pictures, Flash content, widgets. Each multimedia component of the collage may be self or auto playable as well as clickable for enabling further interaction.

### BACKGROUND OF THE INVENTION

PROBLEM DESCRIPTION: During the course of searching for information or shopping on the Internet, a user needs several click-throughs and website visits to gather all relevant information for a product or item of interest. The current interfaces lack the user experience of semantically grouping tasks that users need to perform in order to research information about a particular product or item, thus leading to increased time spent in browsing and context switching between different information sources.

The problem is exacerbated when using mobile devices, because of the limitations in interactivity. Mobile devices have different modalities and form factors from that of their desktop counterparts, which are usually equipped with a full QWERTY keyboard and large screen real estate. However, applications and interfaces that are often suitable for the desktop are simply reused in mobile devices with very minimal optimization. This becomes an issue especially with web pages and web browsing in general, as mobile users are often faced with a myriad of hyperlinks and click-throughs in order to obtain the information they need.

CURRENT USER EXPERIENCE SCENARIO FOR PRODUCT SEARCH: John is interested in buying an HDTV for his home. He decides to go to a comparative shopping website, to get a sense of the different models, and their prices. He first types in the term ‘HDTV’ in the search bar field. He then clicks on one of the HDTV models to find the vendors that carry the model. He then clicks on the Amazon link, to get the product descriptions and price. He then goes to http://www.cnet.com, navigates through their web site to get the user reviews. Then another search through http://www.ratings net's myriad of screens to get the product ratings. He repeats the above process for other models of HDTVs. When he has a few favorite models in mind, he goes to a brick and mortar store like Best Buy to check out some of the HDTVs displayed there. He also makes some phone calls to Sears to figure out their special deals. After several such iterations, he finally purchases an HDTV of his liking.

DESIRED INFORMATION: The consumer is looking to buy a plasma HDTV. He conducts an initial market research on the desktop or mobile Internet to narrow his search. He is then out shopping at a local BestBuy and looking at the various alternatives he has picked, where he can continue his search on his mobile phone. The product attributes and alternatives that he is interested in are listed here:
1) Brand (Sony, Panasonic)
2) Diagonal Dimension (42″,50″)
3) Aspect Ratio (5:4 and 4:3)
4) Warranty At least 2 years (part of this could be manufacturer's warranty and part from a seller)
5) Price (Product+Warranty+S/H+Tax)
6) New/Used. If used maximum of 2 years old.
7) On Line Seller (e.g. Amazon, PriceMad)
8) Seller Rating
9) Product Rating (e.g. Cnet)
10) On Line Customer Reviews (e.g. Amazon)

The ultimate decision is obtaining the “right balance” between all the product criteria. The need is to deliver all the relevant product information in one place, rather than making the user visit multiple websites in order to make an informed decision. The best deal in the consumer's perspective is the price point and reviews that truly reflects his perceived value from the combination of the attributes. In order to get the user close to a purchase decision at this point, the system would lead him through a dialog and display all the possible choices given his criteria in one place. The consumer can then choose the one that best fits his criteria.

In general, we identify several critical issues with the current landscape of comparative shopping for a consumer: 1) Need for several click-throughs and website visits to gather all relevant information. 2) The current interfaces lack the user experience of semantically grouping tasks that shoppers need to perform in order to research information about the product, thus leading to increased time spent in browsing and context switching between different information sources. This problem can be generalized for all services such as NexTag, eBay, Amazon, etc. as illustrated below, where the shopper would need to click through several websites over various iterations to get summaries of product information.

LIMITATION IN INFORMATION DISCOVERY IN THE MOBILE DOMAIN: It has been well studied that consumers consciously leverage various forms of information in making an informed decision to gratify a specific need. During the search for information, news reading and shopping process, Internet and mobile commerce will only be widely accepted if it is perceived as an opportunity to gratify consumers' specific needs for information, knowledge and social acceptance. Currently, consumers are exposed to a large number of Internet based e-commerce and advertising that is PC-centric. More recently to cater to the mobile consumer demand, these same services have been minimally optimized for mobile devices. As the real estate of these mobile devices is significantly smaller and with limited data rate speed, the net experience that consumers get is far from being pleasurable. Apart from mere transforms of PC-centric e-commerce applications to the mobile platform, there has not been any specific attempt in targeting the needs of the mobile device-centric consumer market, where users are usually “on-the-go.” The current services do not effectively facilitate the user to transition from accessing information at leisure on the desktop, to a person on-the-go with a mobile device. The current services simply make available their same desktop-based websites on the mobile browser without considering the limitations of the mobile device modalities.

Mobile search and commerce has the potential of bringing information to the consumers ubiquitously. This in turn creates new avenues for consumer interaction with the search result and related advertisements. In order to design a novel mobile search and commerce service, it must take into account the contextual situation in which consumers are attempting to use the service and also the limitations of the handheld devices. The information or advertisement should provide sufficient experiential satisfaction through aesthetic pleasure, visual experience, emotional stimulation, or social experience.

PRIOR ART: Patent application titled ‘Targeted mobile advertisements’ (#WO2007098487) describes a method of generating relevant advertisements targeted for a mobile device. In order to provide relevant advertisements, in addition to the user's query, additional parameters such as the carrier, device identity, supported languages, landing pages etc. can be used. This in turn generates a response to the query comprising search results and the plurality of advertisements. While the system is a mobile Internet based content delivery system, unlike our invention, the interface and presentation of the results are not specifically optimized for the mobile screen. Further, the presentation of the advertisements is not in the form of collages.

Patent application titled, ‘System, method, and computer program product for providing location based services and mobile e-commerce’ (US20030220835) describes a system, method, and apparatus for providing location based functions and mobile e-commerce comprising a central processing unit including a processor, a storage device, and programming stored in the storage device, a display device, an audio input device, an audio output device, a communications module, a commerce module, an image module, and a location module. The programming controls the operation of the system to provide functions based on location data, to facilitate commercial exchanges by wirelessly exchanging payment and product information with vendors, to identify services such as vendors meeting selection criteria, to wirelessly exchange select information with other users and systems, to restrict and/or monitor the use of the device based on authorized user parameters, selecting one of a plurality networks through which to communicate, detecting a trigger for performing an action based on a change in location and sensed data, storing a voice annotation with a computer data file, determining service providers and associated communication parameters, contemporaneously maintaining a wireless voice and data link, providing a system for selecting and delivering mobile advertisements, and many other functions and services that are described herein. However, our invention differs from this, as we aggregate information from a myriad of information sources into an interactive multimedia collage that can be consumed both on desktop and mobile platforms.

Patent application titled, ‘Message-to-wap link for content and advertising’ (#US20070294725) describes a system for enhancing advertising revenue in mobile communications. In response to a user query from a mobile device, the search service returns an appropriate response to the user via the mobile device. The response integrates an answer to the user's query with relevant advertisements in a single or same display image. The advertisements can include graphic and/or multimedia information; the presentation of such graphic information to the user, together with the unique targeting of ads to answers on the display screen, supports high CPM (cost per thousand views) as desired by advertisers sponsoring the advertisement. Our invention aggregates different facets of the desired information into a homogeneous collage, wherein each component of the collage is interactive and can provide the user with further details about that piece of information.

Patent application titled, ‘Method and System for Content Distribution and Playback in a Mobile Telecommunication Network’ (#WO200779307) describes a system, method, and computer-readable medium for providing distribution and output of content. Content transmitted to a mobile terminal may comprise textual, graphical, audio, multimedia, or other content that may be configured for automatic output or playback. Output or playback of the content may be made in response to an event, such as a user action or an incoming call. Usage statistics related to output or playback of the content may be accumulated by a mobile terminal and periodically reported to a network entity. While this invention concerns the delivery and playback of media in a mobile context, our invention focuses on aggregating different components of information into a collage that exhibits a wide range of interaction capabilities including click-to-call, click-to-text message, click-to-launch a web page, click-to-play video, etc. that is adapted for both desktop and mobile platforms.

Patent application titled, ‘Mobile advertising and directory assistance’ (#US20050245241) describes a system where rich multimedia content is provided to a wireless device, particularly in response to a request for directory assistance generated by a client application. The multimedia content is provided as a multimedia message including bundled multimedia elements such as images, sound, text, and video files. The multimedia elements are compiled into a single multimedia presentation or deck that includes multiple screens that are automatically advanced for the convenience of the wireless device user. The user can interact with elements of the multimedia presentation, for example by placing orders, providing payment information, controlling playback, and forwarding or saving the deck to the wireless device. Multiple decks may be retrieved by a single request, and the decks are presented in an order determined by a bidding system or according to user preferences. Elements can be presented visually and/or audibly, and the user can interact using voice commands, manual entries, or stored entries. While their invention concerns the presentation of multimedia content in the form of multiple decks or presentation, our invention concerns the presentation of the multimedia content into a single multimedia collage wherein different portions of the collage provide different interaction capabilities.

Patent application titled, ‘Method and system for mobile display of context-based advertising content’ (#US20040192351) describes how context-relevant proximity-driven mobile advertising is accomplished by displaying advertisement content at display devices associated with mobile vehicles based on the context of the vehicles, such as location and time. An advertising context module associates plural advertisement contents with selected contexts. An advertising display controller associated with each vehicle uses a location provided by a locator device, such as a GPS locator, to determine a vehicle context and applies the context to select advertisement content for display at the vehicle. Our invention displays collages to the user that are not only context relevant based on location, but are also relevant based on the user's interests, needs, price desired and product features.

Patent application titled, ‘System and method for downloading and storing contact information and advertisements in a communication device’ (#CA2588476) describes systems and methods for downloading and saving contact information of businesses and individuals stored on a central server to the contact list of a communication device. Advertisements in the form of data, audio, video, or image files may be associated with contact information in the central contact information database. The geographical location of the communication device is determined. The contact information, and optionally, associated advertisement information, of business located in proximity to the geographical location are downloaded to the communication device and stored locally within the contact list of the communication device. The contact information may include telephone numbers that can be dialed with a single dialing instruction rather than requiring a user to manually input the telephone number to the dialing pad of the communication device. While their invention concerns the ease of use of a certain type of interaction, namely calling a contact through the provided advertisement, our invention encompasses other interaction capabilities including click-to-call, click-to-text message, click-to-launch a web page, click-to-play video, etc. that is adapted for both desktop and mobile platforms.

Patent application titled, ‘Targeted mobile device advertisements’ (#WO200789967) describes how a targeted advertisement is provided to mobile device users based on one or more keywords in words spoken by the mobile device users. The users may submit voice requests using mobile phones or other mobile networked devices, relevant keyword(s) are determined from the requests and corresponding advertisements and/or products associated with the keyword(s) are provided to the users while the users are waiting for responses to the requests. While their invention concerns the provision of a targeted advertisement based on the user's request, our invention concerns the aggregation of various features of the desired information into a collage.

Web based HTML provides an Image Map, which is one image with multiple “clickable” areas. However, image maps have the following inherent disadvantages: (a) An image-map or an area in an image map takes only one ALT attribute. Thus, it is not possible to have different ALT attributes for different links. Visitors with disability or those using text based browsers might not appreciate this. (b) Only one type of interactivity is possible. You cannot have separate mouse-overs for individual links. (c) An image map is one large image and if it's not optimized properly, will take a long time to download: Our invention creates image collages that support multiple interactions and are optimized for low bandwidth conditions, wherein, the collages are cached onto the device only when high network bandwidth is available and can limit the size of the images to create a more optimal user experience.

Patent application titled. “Weighted interactive grid presentation system and method for streaming a multimedia collage” (United States Patent Application 20010034740), describes a collage solution for simultaneously visualizing elements from a large number of multimedia documents. Placement of elements in the collage is based on a model of their importance to the user. By dynamically prioritizing the allocation of screen space based on the user's interests, the weighted grid presentation system makes the streaming collage a useful and engaging means of visualizing media elements and the documents they represent. While this invention also uses collages for the presentation, it focuses mainly on the streaming optimization of the various elements comprising the collage. Our invention, on the other hand, automatically creates one concise collage of multi-faceted information/content from various sources for a given search query from a user.

### BRIEF SUMMARY OF THE INVENTION

There are 4 key areas that are addressed in our invention

CONTENT: The success of any information or product search strongly depends on the content delivered to the user through the search result. Content is a key factor in creating a service that attracts the users, keeps them coming back, and recommend the service to their friends. Based on our invention the content comes from different sources and are composited together as mashed collages that can be viewed easily.

RELEVANCE: Based on our invention, collages are created from different sources and users may choose the source of content, which maximizes the relevance of the result. In addition, the collages are created from the context of the mobile device as well. For example, showing information about a product from a store located near the user's current location.

CUSTOMIZATION: Customization is important when delivering the result through mobile devices for users on the go. Most mobile users maintain a very personal and intimate relationship with their mobile phones. Service providers need to understand the critical elements underlying personalization of the services. Thus, customization is a key element of successful search result delivery based on individual preferences, needs, lifestyles, and cultural as well as geographical differences. Based on our invention, users have access to customize their collages, the placement of information, size and dimension and so on.

PRESENTATION: Based on our invention, the search result is concise with relevant visual imagery, which enhances the user experience, reduces the time to review the result, and overcomes the challenges of delivering result through mobile interface. A summarized semantically relevant collage compositing the relevant content is key to conveying an idea concisely and should employ language or image that the target group understands, and utilize the available space or characters effectively. The higher the utility factor of the search result, the higher the perceived value it is to the consumer. Currently, there is no such search result system that uses visualization and imagery to deliver information to the consumer effectively.

INTERACTIVITY: So far, current state-of-the-art systems have failed to take the advantage of the full potential of interactive marketing and search results, in particular targeted to the small display of mobile devices. Our invention provides methodologies for the creation of interactive messages that would facilitate full interactive desktop and mobile experience.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1. is a schematic block diagram of current methods of search and user experience.

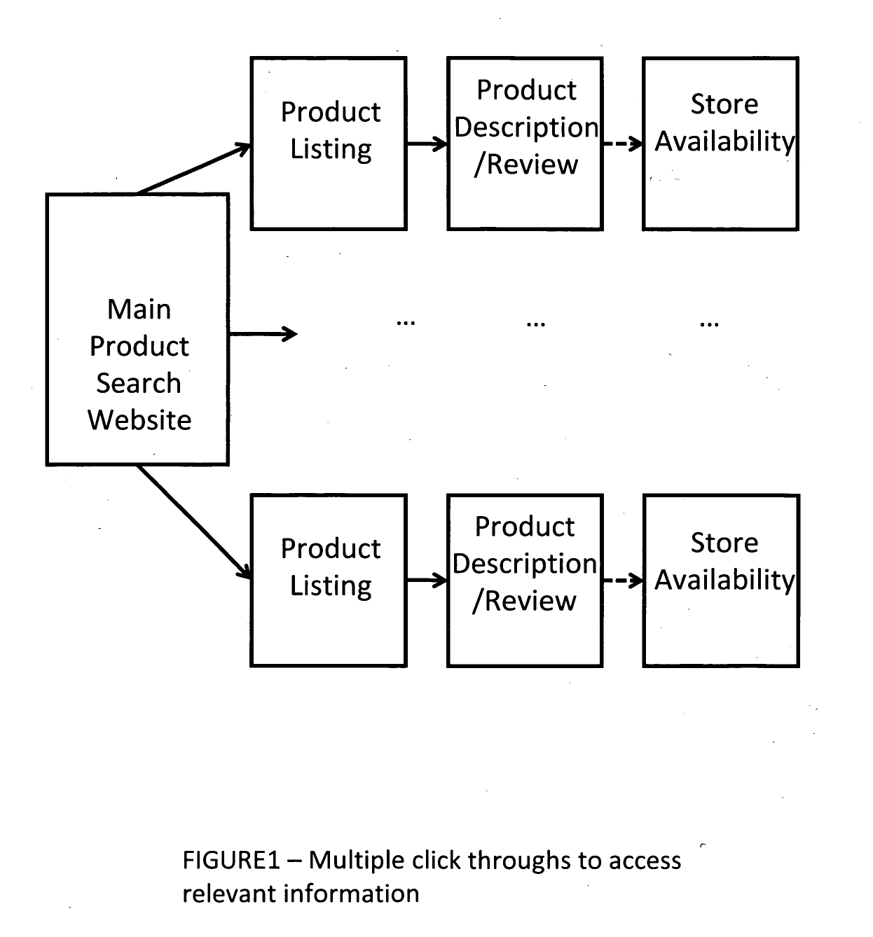

FIG. 2. is a pictorial description of the modules in the system.

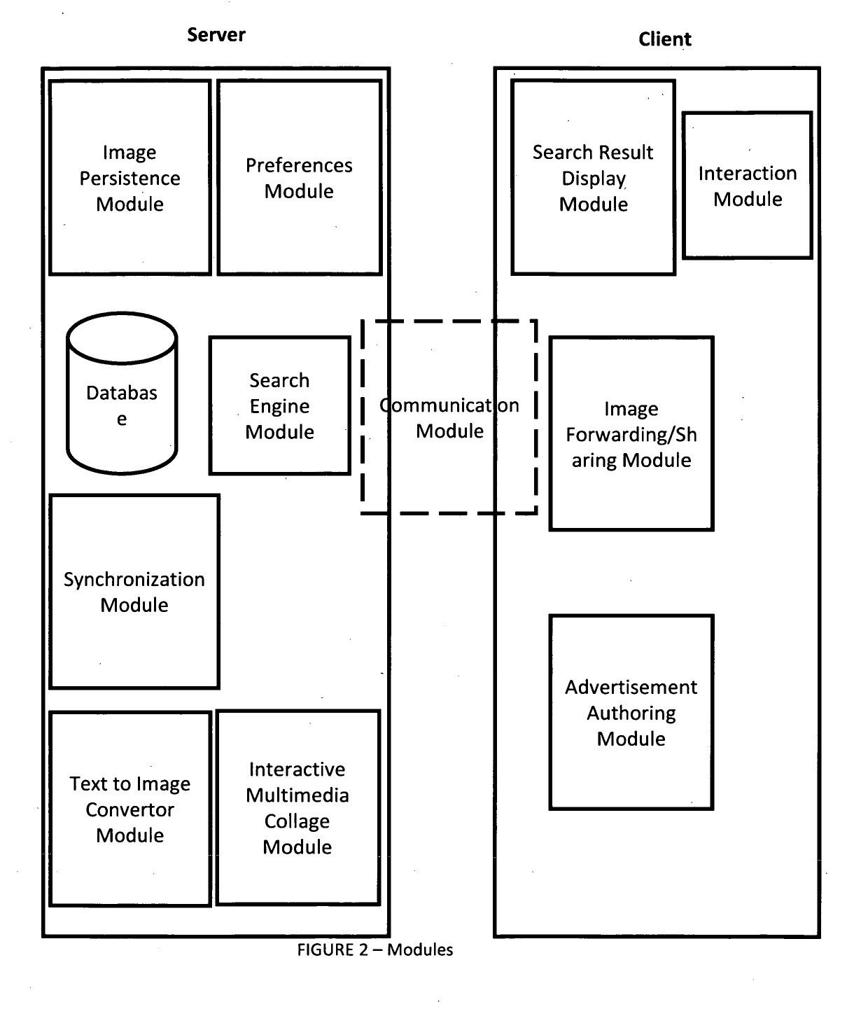

FIG. 3. Sample of collages which is created by our invention and could be delivered to consumers, according to one embodiment.

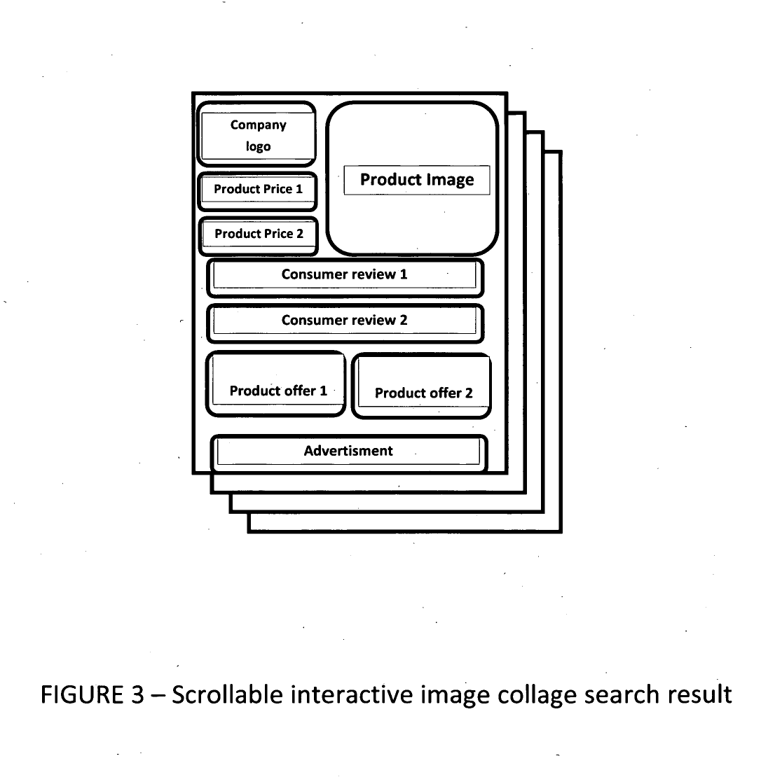

FIG. 4. Data flow diagram of the system. The server component in this diagram corresponds to the server in FIG. 2. The ‘Search result Display’, ‘Interaction’, and ‘Image Forwarding/Sharing’ client Modules as described in FIG. 2 reside on the display devices of the Consumer in FIG. 4. The ‘Advertisement Authoring’ Module as described in FIG. 2 is used by the Advertisers and Retailers as shown in FIG. 4.

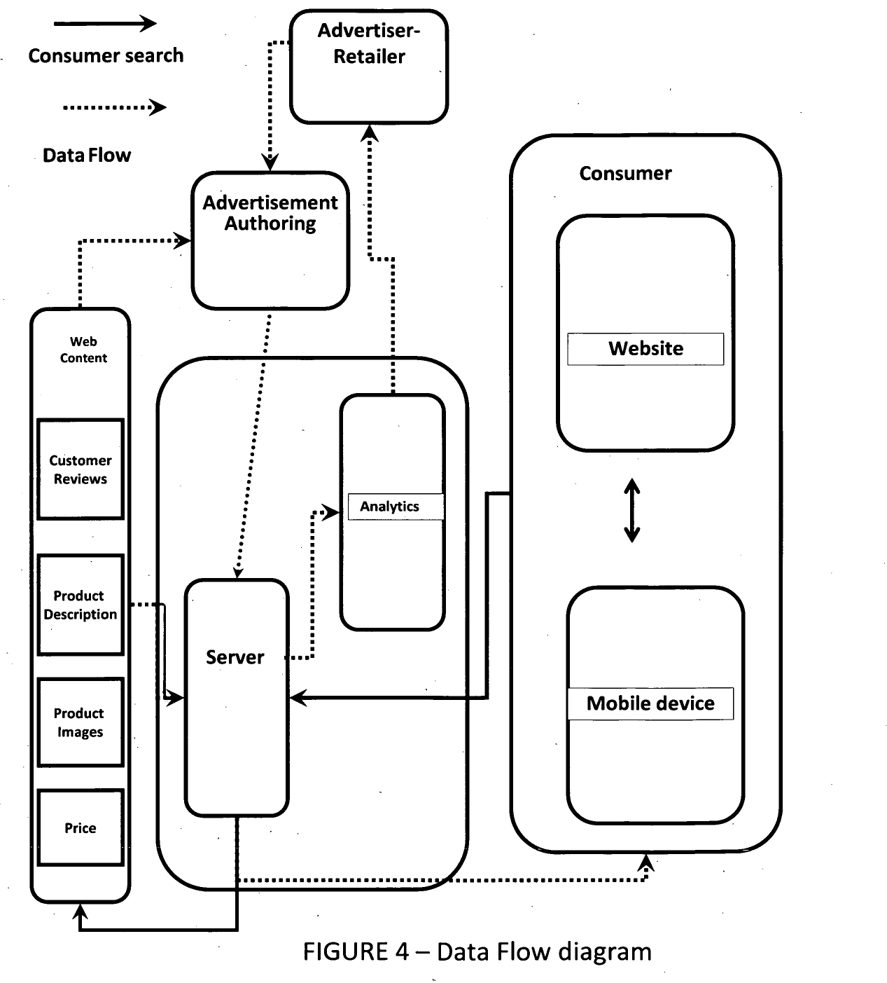

### DETAILED DESCRIPTION OF THE INVENTION

In comparison to existing products and prior art, the current invention provides an enhanced user experience for consumers by minimizing the number of click-throughs, and optimizing time spent by providing customizable, interactive visual multimedia collages of information created from several sources of information. Moreover, this Desktop experience is made available for the users on-the-go on their mobile devices where the users can access the same collages and interact with them in a manner meaningful to the modalities provided on the mobile device, such as phone calls, text messaging, and WAP browser viewing.

When interacting with the collages, the interested consumers will be directed from the image collage result sets to content provider or retailers' web sites. Further, the invention's viral marketing features will help retailers reach scores of potential customers with minimal effort from the retailer's end. Content providers and retailers can easily move their online marketing to the mobile domain with minimum cost and infrastructure spend. Using the technology, companies can initiate their mobile campaigns to interested consumers and provide targeted and location based offerings anytime, anywhere through their mobile devices. Through its analytics engine, the invention will provide to the retailers competitive location based information, consumer behavior data for advertising, and location based product demand.

On the Desktop Internet/mobile device, the consumer could set the preferences that may not necessarily be product specific but could apply across all interactions (e.g. favorite on-line product rating source) using the preferences module. The consumer then uses the search engine that takes him through a dialog to choose the product/information category, and product/information characteristics that is of interest. Each search result is a scrollable set of interactive images. Each image has all the information: the advertisement from the seller, customer review, product rating, and seller rating etc. composited together. In one embodiment, the consumer can click on any of the regions (e.g. customer surveys) to click through to the related web site housing the information. In other embodiments, the consumer can just browse the information, consummate a buy transaction on-line: get it shipped or pick it up himself, place a bid for a used product, and/or call a number for more information. The consumer can save any of the interactive images using the image persistence module.

For enterprises, retailers, and individuals interested in selling new/used products, they can create advertisements for their products using the Internet web based advertisement authoring module. These collages are stored in a repository that can be either central or distributed by nature.

MODULE DESCRIPTIONS: The consumers can interact with the server via any Internet browser in the desktop. On the mobile device, the consumers can interact with the server either through a thick client that resides on the phone or through a thin client/browser. This special browser is used to browse and interact with the information collages. This browser can either be, but not limited to being part of a thick client residing on the phone or exist as a plugin in a web browser or part of a widget residing on the phone. This browser is capable of reading the information collage format along with its associated metadata to support features such as caching, preview pages, special animations, plugins to 3rd party services such as voice recognition, etc.

Preferences Module: The preference settings module allows the consumer to set their preferences for information sources e.g. favorite on-line/brick ‘n’ mortar seller(s) (Amazon/Macy's etc.), preferred on-line customer reviews source (e.g. Amazon), favorite product rating source (e.g. cnet), as well as desired visual layouts of the collages themselves. These settings will apply to any transaction that the consumer initiates and is stored in the profile of the consumer. If the consumer wishes, the preferences can be synchronized to a central server using the synchronization module that can be used to backup all saved preferences and interactive images to the server.

Search Engine Module: The search engine takes the consumer through a dialog in the course of which she chooses the information/product category, and the information/product characteristics that she prefers. In one embodiment the dialog could be presented as a forms based user interface. In another embodiment, the search dialog could be a multiline keyword entry supported by a multiword autocomplete feature. In the case of the plasma HDTV the search criteria could be brand, diagonal dimension, aspect ratio, and warranty. Users can also indicate their interests in a brick ‘n’ mortar store or an on-line seller. In the case of a brick ‘n’ mortar choice, they can further qualify their interest by indicating how far they are wiling to travel. The users can also indicate if they are interested in a new or used product.

Text to Image Convertor Module: This module takes the textual data associated with the search results and creates images from them. These individual images are aesthetically pleasing with the primary goal of being recognizable and informative as much as possible to the user. For example, textual data concerning the rating of a product is automatically converted pictorially into a star based image rating

Interactive Multimedia Collage Creator Module: The interactive information collage creator creates each of the collages by compositing together the individual images generated by the Text to Image Convertor. The consumer can click on any of the hyperlinks (e.g. customer surveys) to click through to the WAP site or Internet site housing the information. The technologies supported by the system will include and not be limited to WAP/WML and HTTP/HTML as long as the device supports them. If the device does not support these technologies, a bitmap image will be supported that will not be interactive.

Search Result Display Module: The search result is a scrollable set of interactive, information collages. The search result display module is used to display the result set. Each information collage image has different facets of information composited together. For example, an advertisement type of collage may have the following information composited together: 1) The advertisement from the seller, 2) Customer review and product Rating (from consumer preferred source, Ad Authoring Tool or dynamically generated by server), 3) Seller rating. The consumer can click on any of the interactive regions (e.g. customer surveys) to click through via a hyperlink to the WAP site or Internet site housing the information.

Interaction Module: The consumer can interact with each image; 1) Just browse the information, 2) Click through to the referred web site or WAP site, 3) Click-to-Buy: Consummate a buy transaction on-line (get it shipped or pick it up himself), 4) Click-to Bid: Place a bid for a used product, or/and, 5) Click-to-Call: Call a number for more information.

Image Persistence Module: The consumer can save any of the interactive collage images using the image persistence module. The interactive image will be stored along with all the hyperlinks. The consumer can choose from various caching mechanisms like Least Recently Used (LRU), and Least Frequently Used (LFU) to decide which images will be deleted to make space for new ones. The interactive images can be stored in an online account.

Image Forwarding/Sharing Module: The consumer can forward the saved information collages to their friends. In one embodiment the account identification information may be used to forward a collage to a user on the desktop Internet. On the mobile device one embodiment could use the following algorithm: 1) The lightweight client will ask the userid or phone # of the recipient, 2) The user IDs are tied to their mobile phone # in the server, 3) The client uses an available communication protocol to see if the lightweight client is installed on the recipient's cell phone, 4) If yes, it forwards the whole file in a proprietary format, 5) If not, it forwards to target cell phone # only as wap wml or html using email or mms. If the recipient's mobile device does not have the lightweight client installed, there will be a link in the information collage to download the client for full interactive capabilities.

Communication Module: The communication module facilitates all communication from the mobile device or desktop to the server. Based on the technologies supported by the device the system will support: WTP/WTLS, HTTP/HTTPS, and SMS for mobile communication. On the desktop, Internet standard browser communication (HHTP/HTTPS) is used.

Synchronization Module: Based on consumer preferences, the synchronization module can be used to backup all saved preferences and interactive images to the server.

Advertisement Authoring Module: Sellers of new/used products can create information collages using the Internet web based Advertisement authoring tool. These information collages are stored in the central server. These advertisements could contain: 1) Photographs, 2) Product Descriptions, 3) Price Information, 4) Call-back telephone number, 5) Any WAP or Internet content that is provided in the Authoring tool palette. These can be: 1) Other On Line Seller Ads, 2) Product Ratings, 3) On Line Customer Reviews. The information collage authoring tool can be accessed manually through all standard web providers with a web based user interface to create interactive images.

The goal for the information collage authoring tool is to enable searchable, interactive, intelligent visual images for multiple applications. The images are: 1) Searchable: The images are connected with different annotations, keywords, and www addresses which are searchable through any search engine, 2) Interactive: The images have different embedded interactive solutions in different parts of the real estate, 3) Intelligent: The image can be created automatically through request placed in a search engine,

Some of the applications of the information collage authoring tools and image collages may include but not limited to: 1) Search: Painkiller for search engines, providing automatic image illustrations for search results (e.g. Google, Yahoo . . . ). This is applicable to both the Internet platforms and the mobile platforms, 2) Auction: Providing web based user interfaces for consumers to create interactive auction images for selling products (e.g. eBay . . . ) This is applicable to both the Internet platforms and the mobile platforms, 3) Mobile Advertisements: Maximizing the usage of mobile screen real estate, 4) Internet Advertising: Reducing the number of clicks to access all the information needed for a purchasing decision, 5) Information, news, created dynamically

SERVICE: The proposed service includes creation of information collages with visually integrated clickable sub-regions and consumption on the desktop/Internet and mobile devices. Consumers are able to use our unique software to create their own customized desktop/mobile ads and use our service to send it to friends, and other individuals who are searching for the specific products, interested in knowing more about available products in the same category or similar kind of content and information. As the format of the image collage is proprietary, the consumers have to download the proposed lightweight client to interact with the image collage. The service facilitates selling, searching, bidding and buying personal products or searching, finding and interacting with any content or information.

What is claimed is:

1) A novel method for desktop Internet/mobile users:
a) Providing a set of holistic interactive information/advertisement multimedia collages from various heterogeneous content/data sources to the user on the display device as a result of product/service/content/information searches. Multimedia collages are presentations for simultaneously visualizing content from a large number of multimedia sources, including but not limited to web content, video, pictures, Flash content, widgets. Each multimedia component of the collage may be self or auto playable as well as clickable for enabling further interaction.
b) Minimizing the number of clicks for accessing information by compositing individual pieces of relevant data into a single information collage on the display device.
c) Creating a new interactive surface for the information collage, wherein the consumer can click on different regions in order to access more information about the item, product, topic or service on the display device.

2) The method of claim 1 further comprising a mobile service that facilitates consumer-specific information browsing and consumption of information collages via a thick or thin client residing on the phone and/or a clientless solution accessible over the Internet.

3) The method of claim 1 further comprising a desktop or interactive display service that facilitates consumer-specific information browsing and consumption of information collages via a web browser or software application, that provides seamless compatibility for viewing and transfer of collages and user preferences between a multitude of display devices.

4) The method of claim 1 further comprising a client that users can download onto their mobile devices in order to view, interact with, forward and save the information collage. This client can also be used to create new customized advertisement and content based multimedia collages based on customer preferences of product and content/data sources. This special browser is used to browse and interact with the information collages. This browser can either be, but not limited to being part of a thick client residing on the phone or exist as a plugin in a web browser or part of a widget residing on the phone. This browser is capable of reading the information collage format along with its associated metadata to support features such as caching, preview pages, special animations, plugins to 3rd party services such as voice recognition, etc.

5) The method of claim 1 wherein this invention introduces a new format for an information collage that can be viewed, interacted, forwarded and saved as one single file, on the display device.

6) The method of claim 5 wherein this information collage format when present on the mobile device provides different behaviors based on the presence or absence of the lightweight client on the device. In the absence of the lightweight client, the information collage format provides limited interactivity to the user. However, the format provides a mechanism for obtaining the client onto the mobile device. Then the user can view and interact more with the information collage.

7) The method of claim 1 further comprising different interactivity options for the information collage service based on various service parameters/agreements/characteristics on the display device.

8) The method of claim 4 wherein the lightweight client unobtrusively sits on the mobile device and downloads information collages that the consumer is interested in. This client takes into account certain parameters such as device memory, amount of battery remaining and network/bandwidth access to determine when and how many information collages are to be cached onto the mobile device at a given time.

9) The method of claim 1 wherein the image content that is displayed as a result of the search may include the following but not limited to: 1) Photographs, 2) Product Descriptions, 3) Price Information, 4) Customer review, 5) Product Rating from, 6) Seller rating, 7) Call-back telephone number, 8) Any WAP or Internet content (Other On Line Seller Ads, Product Ratings, On Line Customer Reviews), 9) Videos, 10) Flash Content, 11) Widgets.

10) The method of claim 1 wherein on each of the image in the resulting collage the consumer may perform any of the following interactions but not limited to: 1) Just browse the information, 2) Go to the referred web site, 3) Go to the referred WAP site, 4) Consummate a buy transaction on-line (get it shipped or pick it up himself), 5) Place a bid for a used product, or/and, 6) Call a number for more information, 7) Click to store finder-locate the retail shop closest to the consumer, 8) SMS/MMS, 9) Email, 10) Click to view video, 11) Click to gift finder, 12) Click to download mobile content, 13) Click for coupon, 14) Click to take a quiz and so on

11) The method of claim 1 further comprising a service that caters to the user's preferences. The user requests information for product/service/content from the server. Server dynamically creates a collage of the information if all the requested elements are available. If not, the server intelligently creates or picks the closest collage matching the preference. These collages could be pre-defined advertisements that are created by ad-creators or those that are dynamically created in a customized manner by the server to closely match the preferences of the buyer. These collages are created through specially assigned parsers that can parse pre-approved content from the participating vendor's web page or plurality of web pages. This would work on any display device.

12) The method of claim 11 wherein the service facilitates online searches for collage results by suggesting to the user, a query auto-completion of terms and phrases during the query entry process. The suggested strings in the auto-complete query are based on specific attributes of the product/service/content in the database such as product category, brand, and color. Further, the auto-complete algorithm takes into account items that are currently the most popular (e.g., best selling or most frequently viewed), and may be customized to particular users or user groups. The auto-complete feature is also present on users' computing devices, which may include handheld and other wireless devices that lack a full keyboard.

13) The method of claim 11 wherein the service takes textual information from various sources and converts them into a pictorial form that are individual units of the collage. These individual image units of the collage are aesthetically generated and are visually recognizable on a given display device.

14) The method of claim 11 further comprising of various settings that are provided to the desktop/mobile device consumer on the client to view desired percentage of predefined and customized information collages.

15) The method of claim 11 wherein the server maintains an in-memory cache of the product/service/content's metadata in a data structure that facilitates fast context dependent search. The order of product/service/content criteria entered by the user in the auto-complete dictates relevancy. Product/service/content search criteria entered before others are considered to be more important and relevant to the user. The search process uses the relevance to search the cache and the cache is structured in a manner to help in this process.

16) The method of claim 11 further comprising of mechanisms for storing user preferences in a secure and persistent state for enhancing the relevance of our service on the display real estate. The consumer could set their preferences for information sources e.g. favorite on-line/brick ‘n’ mortar seller(s) (Amazon/Macy's etc.), preferred on-line customer reviews source (e.g. Amazon), favorite product rating source (e.g. cnet). These settings will apply to any transaction that the consumer initiates and is stored in the profile of the consumer.

17) The method of claim 11 where in the technology lets content providers, retailers and others provide targeted and location based offerings anytime, anywhere through display real estate.

18) The method of claim 11 wherein revenue earned through our information collage service is based on but not limited to several parameters: how much of the collage's real estate is used, placement of information in the collage, what type of interactive surface is mapped to the part of that collage (e.g. whether it's a mere banner, click-to-payment, view a web page, call the seller, etc.), the order in which it appears in the scrollable set of relevant collages on the mobile client (e.g. the first collage may be charged a premium to the seller)

19) An advertisement authoring tool to intuitively create information collages by advertisement creators from different sources of information.

20) The method of claim 1 wherein information collages created are searchable via any Internet based search engine.

21) An analytics engine, that will provide to the retailers competitive location based information, consumer behavior data for advertising, and location based product demand. The analytics engine operates on the data that is captured from search keywords entered by the users, context like their location, and their interactions with the multi-media collage.

22) The method of claim 1 further comprising of enabling the creation of automatic customized individual catalogs based on search criteria to be delivered through different channels to users in a timely manner. These catalogs may contain the results of several searches of a user.

23) The method of claim 1 wherein apart from 2D content, 3D multimedia search, optimized delivery & dynamic adaptation enabling multilayered, multi-views content coding and interactive collage creation.
